(19) United States
(12) Patent Application Publication
(10) Pub. No.: US 2011/0080944 A1
(43) Pub. Date: Apr. 7, 2011

(54) REAL-TIME VIDEO TRANSCODER AND METHODS FOR USE THEREWITH

(75) Inventors: Feng Pan, Richmond Hill (CA); Yang Liu, Richmond Hill (CA)

(73) Assignee: VIXS SYSTEMS, INC., Toronto (CA)

(21) Appl. No.: 12/574,802

(22) Filed: Oct. 7, 2009

(51) Int. Cl. H04N 7/26

(52) U.S. Cl. 375/240.02; 375/240.26; 375/240.16; 375/E07.124; 375/E07.2; 375/E07.126

(57) ABSTRACT

A transcoder includes a direct transcoder that generates a first portion of a transcoded video stream by reusing a plurality of encoding parameters of a compressed video stream. A cascaded transcoder generates a second portion of the transcoded video stream by decoding the compressed video stream into video data in an uncompressed video format and by re-encoding the video data. A transcoding decision generator generates a transcoding indicator, based on the compressed video stream. A switching module selects the direct transcoder for the first portion of the transcoded video stream and the cascaded transcoder for the second portion of the transcoded video stream, based on the transcoding indicator.

### CROSS REFERENCE TO RELATED PATENTS

NOT APPLICABLE

### TECHNICAL FIELD OF THE INVENTION

The present invention relates to transcoders used in video processing.

### DESCRIPTION OF RELATED ART

Video encoding has become an important issue for modern video processing devices. Robust encoding algorithms allow video signals to be transmitted with reduced bandwidth and stored in less memory. However, the accuracy of these encoding methods face the scrutiny of users that are becoming accustomed to greater resolution and higher picture quality. Many standards have been promulgated for many encoding methods including the H.264 standard that is also referred to as MPEG-4, part 10 or Advanced Video Coding, (AVC). In some circumstances, a compressed video stream that was encoded in one format for transmission or storage must be transcoded into a different format for use with other devices, such as for storage or display.

Direct transcoding is the process of re-using encoding parameters of a compressed video signal to generate a transcoded version of the signal in a target video format. Direct transcoding avoids the increased complexity and the losses induced by having to fully decode and re-encode the compressed video signal into the target format. Direct transcoding, however, can yield poor results in some circumstances.

The limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIGS. 1-3 present pictorial diagram representations of various video devices in accordance with embodiments of the present invention.

FIG. 4 presents a block diagram representation of a video device in accordance with an embodiment of the present invention.

FIG. 5 presents a block diagram representation of a transcoder in accordance with an embodiment of the present invention.

FIG. 6 presents a temporal block diagram representation of the transcoding of an example video signal in accordance with an embodiment of the present invention.

FIG. 7 presents a block diagram of a transcoding decision generator in accordance with an embodiment of the present invention.

FIG. 8 presents a block diagram of another transcoding decision generator in accordance with an embodiment of the present invention.

FIG. 9 presents a flowchart representation of a method in accordance with an embodiment of the present invention.

### DETAILED DESCRIPTION OF THE INVENTION INCLUDING THE PRESENTLY PREFERRED EMBODIMENTS

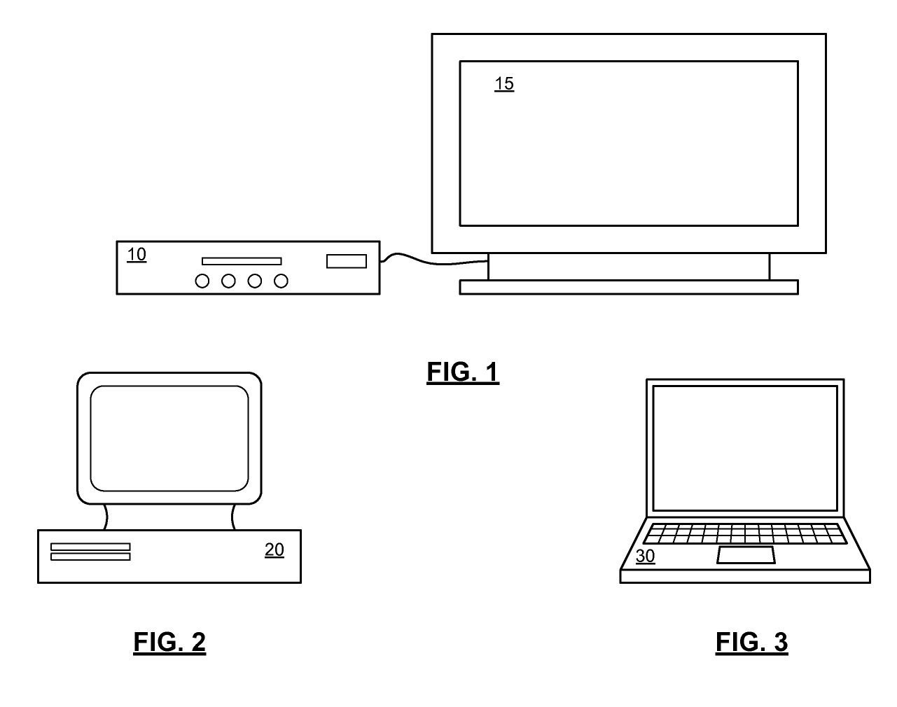

FIGS. 1-3 present pictorial diagram representations of various video devices in accordance with embodiments of the present invention. In particular, set top box 10 with built-in digital video recorder functionality or a stand alone digital video recorder, television or monitor 15, computer 20 and portable computer 30 illustrate electronic devices that incorporate a video device that includes one or more features or functions of the present invention. While these particular devices are illustrated, the video device of the present invention includes any device that is capable of transcoding video content in accordance with the methods and systems described in conjunction with FIGS. 4-9 and the appended claims.

FIG. 4 presents a block diagram representation of a video device in accordance with an embodiment of the present invention. In particular, this video device 125 includes a receiving module 100, such as a television receiver, cable television receiver, satellite broadcast receiver, broadband modem, 3G transceiver, network connection or other information receiver or transceiver that is capable of receiving a received signal 98 and extracting one or more video signals 110 via time division demultiplexing, frequency division demultiplexing or other demultiplexing technique. Video processing device 125 is coupled to the receiving module 100 to transcode the video signal 110 for storage, editing, and/or playback in a format corresponding to video display device 104. Video processing device 125 includes transcoder 102 that processes video signal 110 to produce a processed video signal 112 as a part of the transcoding of the video signal 110. While video display device 104 is shown separate from video device 125, in other embodiments it can be incorporated within video device 125. Further, while receiving module 100 is shown as being a part of video device 125, it may be incorporated in a separate device or omitted altogether.

In an embodiment of the present invention, the received signal 98 is a broadcast video signal, such as a television signal, high definition television signal, enhanced definition television signal or other broadcast video signal that has been transmitted over a wireless medium, either directly or through one or more satellites or other relay stations or through a cable network, optical network or other transmission network. In addition, received signal 98 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 can include a compressed digital video stream that has been coded in compliance with a digital video codec standard such as a Moving Picture Experts Group (MPEG) format (such as MPEG1, MPEG2 or MPEG4), Quicktime format, Real Media format, Windows Media Video (WMV), or Audio Video Interleave (AVI), etc. and is being transcoded by transcoded 102 to produce processed video signal 112 in a different resolution, scale, data rate, compression format and/or other digital video format.

Video display device 104 can include a television, monitor, computer, handheld device or other video display device that creates an optical image stream either directly or indirectly, such as by projection, based on the display or further decoding the processed video signal 112 either as a streaming video signal or by playback of a stored digital video file.

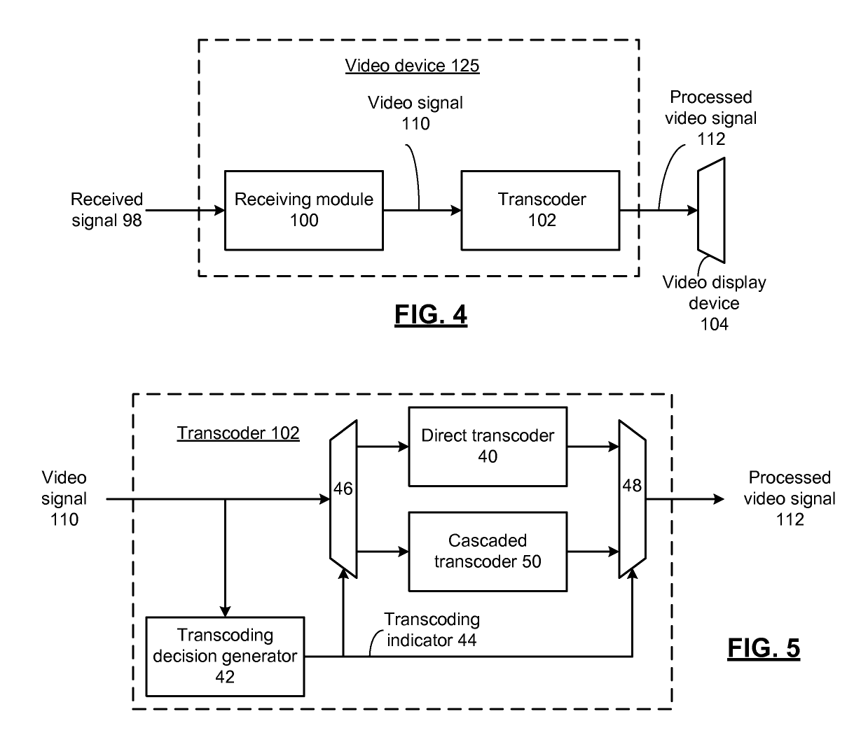

In accordance with an embodiment of the present invention, the video device 125 includes a transcoder 102 in accordance with any or all of the optional functions and features described in conjunction with FIGS. 5-9 that follow.

FIG. 5 presents a block diagram representation of a transcoder 102 in accordance with an embodiment of the present invention. In particular, a transcoder 102 is shown as described in conjunction with FIG. 4 for transcoding a compressed video stream such as video signal 110 into a transcoded video stream such as processed video signal 112.

Transcoder 102 includes a direct transcoder 40 that generates portions of the transcoded video stream by reusing a plurality of encoding parameters of the compressed video stream. In particular, direct transcoder 40 can operate to reuse the picture types, motion vectors, coding modes and/or bit allocation information from the video signal 110 in the production of its portion of the processed video signal 112. In contrast, cascaded transcoder 50 includes a video decoder that decodes other portions of the source digital video format of the video signal 110 into video data in an uncompressed video format such as raw YUV data. Cascaded transcoder 50 further includes a video encoder that re-encodes the uncompressed video data into the target digital video format of processed video signal 112.

Transcoding decision generator 42 generates a transcoding indicator 44 based on the compressed video stream to indicate whether portions of the video signal 110 should be either direct transcoded by direct transcoder 40 or cascaded transcoded by cascaded transcoder 50. A switching module, shown as implemented by multiplexer 46 and demultiplexer 48, selects the direct transcoder for some portions of the transcoded video stream and the cascaded transcoder for other portions of the transcoded video stream, based on the transcoding indicator 44. In an embodiment of the present invention, the transcoding indicator can be implemented via flags, status bits or other logic variables that indicate directly, via unique values, whether direct or cascaded transcoding has been selected.

Under many circumstances, direct transcoding of the video signal 110 to another digital format can outperform a full decoding/re-encoding of a cascaded transcoder in terms of both computational complexity and quality. For example, the direct transcoding of an MPEG-2 compressed video stream to H.264/AVC in the same output bitrate can result in a quality loss of only 0.5 dB, compared with a quality loss of 2 dB by the decoding and re-encoding performed by a cascaded transcoder. However, in other circumstances, direct transcoding of the digital video signal 110 can yield higher quality losses when compared with cascaded transcoding.

For example, in MPEG-2 video coding standards, motion vector coding is not included in the overall cost for mode decision. This can result in very poor and inconsistent motion vectors. In addition, in some encoding, such as MPEG-2 encoding, a group of pictures (GOP) of all P-picture type are often used to code fast motion scenes because there was not enough processing power to perform bi-directional motion estimation. Further, frame picture encoding is the mainstream format in many legacy encoding formats such as MPEG-2, even though field picture based coding could achieve better performance for some video contents. In each of these circumstances, direct transcoding of such compressed video streams can yield poorer picture quality when compared with full decoding and re-encoding performed by a cascaded transcoder.

In an embodiment of the present invention, the transcoding decision generator 42 operates on a real-time basis to analyze portions of the video signal 110 to determine if direct transcoding or cascaded transcoding should be applied. For example, the transcoding decision generator 42 can operate on each picture, or portion of a picture such as an MB, of the video signal 110 and generate the transcoding indicator 44 for the compressed video stream on a picture-by-picture basis. In this fashion, the transcoding of the video signal 110 can be adapted and optimized based on the characteristics of the compressed video stream.

Transcoder 102 can be implemented using a single processing device, a shared processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. Such a memory may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

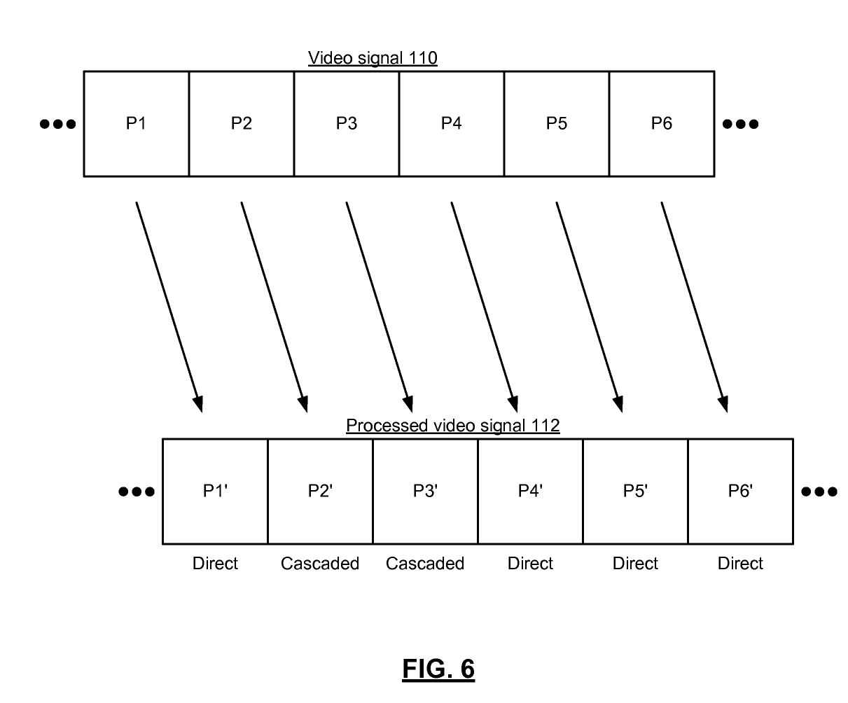

FIG. 6 presents a temporal block diagram representation of the transcoding of an example video signal in accordance with an embodiment of the present invention. In the example shown, video signal 110 includes a sequence of pictures (P1, P2, P3, P4, P5, P6, . . . ) encoded in a compressed video format such as an MPEG-2 format. As discussed in conjunction with FIG. 5, the transcoding decision generator 42 operates on a real-time basis to analyze portions of the video signal 110 to determine if direct transcoding or cascaded transcoding should be applied.

In the example shown, the transcoding decision generator analyses the pictures of video signal 110 and generates the transcoding indicator 44 for the compressed video stream on a picture-by-picture basis. Example selections indicated by the transcoding indicator 44 are shown in Table 1.

TABLE 1
Example transcoding selections

| Source Picture | Transcoding Indicator |
|---|---|
| P1 | Direct |
| P2 | Cascaded |
| P3 | Cascaded |
| P4 | Direct |
| P5 | Direct |
| P6 | Direct |

As a result, pictures P1, P4, P5 and P6 are direct transcoded into pictures P1′, P4′, P5′ and P6′. Pictures P2 and P3 are cascade transcoded into pictures P2′ and P3′.

It should be noted that the above decision making process can be applied to portion of a picture such that some MBs are direct transcoded while others are cascaded transcoded.

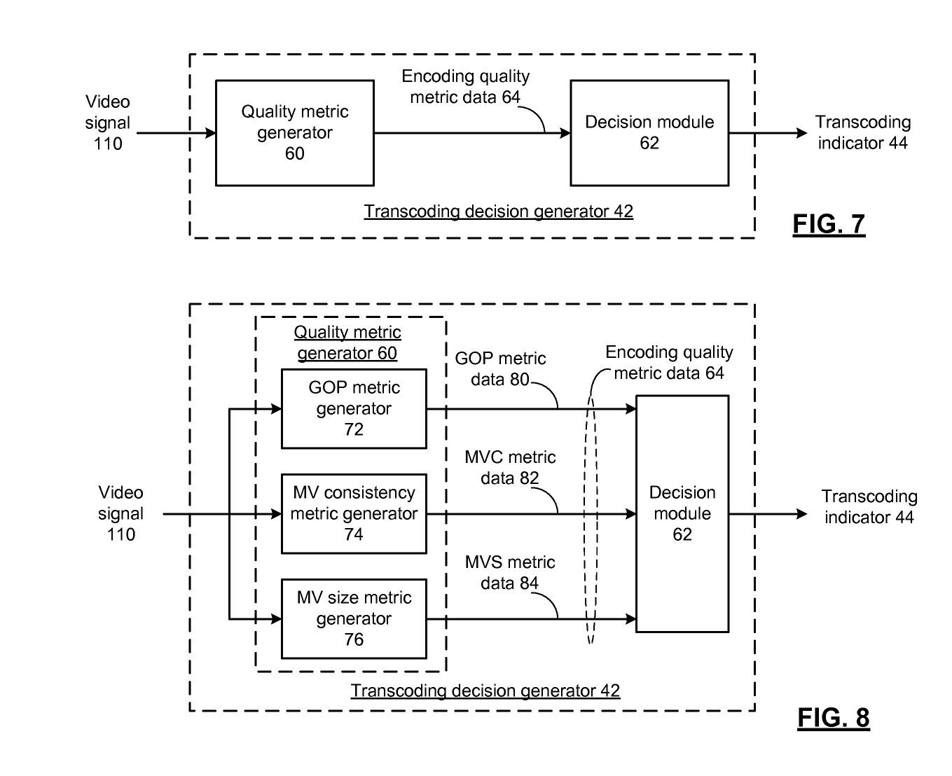

FIG. 7 presents a block diagram of a transcoding decision generator in accordance with an embodiment of the present invention. Transcoding decision generator 42 includes a quality metric generator 60 that generates encoding quality metric data 64 based on a compressed video stream such as video signal 110. Decision module 62 generates the transcoding indicator 44 based on the encoding quality metric data 64.

In an embodiment of the present invention, the quality metric generator 60 analyzes portions of the video signal 110 to determine the encoding quality of those portions of video signal 110. For each portion of the video signal 110, quality metric generator 60 generates the encoding quality metric data 64 based on how well that portion of the video signal 110 has been encoded, and in particular, the suitably of reuse of the various encoding parameters of that portion of the video signal 110 for direct transcoding. In turn, the decision module 62 decides on the basis of the encoding quality metric data 64 whether to direct transcode or cascade transcode each portion of the video signal 110. For example, decision module 62 can operate to compare the encoding quality metric data 64 to one or more quality thresholds. When the encoding quality metric data 64 compares unfavorable to a quality threshold, indicating a poor quality encoding, a full decoding/re-encoding can be indicated to avoid reusing the encoding parameters for this portion of the video signal 110.

In this fashion, the transcoder 102 can perform direct transcoding, making use of picture types, quantization parameters, motion vectors, and/or other encoding parameters of the video signal 110 in circumstances where the video signal 110 has good and consistent motion vectors and normal GOP structures, such as pictures that reflect slow motion, etc. In circumstances where the video signal 110 has poor motion vectors or abnormal GOP structure such as pictures that reflect very fast motion, a full decoding and re-encoding can be performed to transcode the video signal 110 into the processed video signal 112.

FIG. 8 presents a block diagram of another transcoding decision generator in accordance with an embodiment of the present invention. In particular, quality metric generator 60 includes a group of picture (GOP) metric generator 72 that generates GOP metric data 80, a motion vector consistency generator 74 that generates motion vector consistency metric data 82 and a motion vector size generator 76 that generates motion vector size metric data 84. The operation of the various modules of transcoding decision generator 42 can be described in conjunction with the following illustrative embodiment.

Motion vector consistency metric generator 74 operates to calculate the number of consistent motion vectors for a picture of video signal 110. In particular, motion vector consistency metric generator 74 can perform the following for each motion vector in a picture:
1. Determine a consistency threshold based on the picture type (I, B or P) and the macroblock (MB) type based on macroblock adaptive frame and field (MBAFF) implementations via a look-up table or otherwise. For example, the difference threshold can be decreased for field MB motion vectors in P-pictures, increased for B-pictures, etc.
2. For inter-coded motion vectors corresponding to a macroblock of the same MB-type as the previous macroblock, calculate a motion vector difference between the current and previous motion vector, based on a sum of absolute differences;
3. Compare the motion vector difference to the consistency threshold (for the picture and MB type) and increment a small difference count if the motion vector difference is less than the consistency threshold.
4. For skip mode motion vectors, increment the small difference count automatically.
5. Output the small difference count as the motion vector consistency metric data 82.

Motion vector size metric generator 76 operates to calculate an average motion vector size for a picture of video signal 110. In particular, motion vector size metric generator 76 can perform the following for each motion vector in a picture:
1. Calculate a motion vector size as the magnitude of each inter-coded motion vector.
2. Calculate an average motion vector size by accumulating the motion vector sizes and dividing by a count of the number of motion vectors.
3. Output the average motion vector size as the motion vector size metric data 82.
   While the motion vector size metric generator 76 and the motion vector consistency metric generator 74 are shown as separate modules, the functionality of these modules can be combined and performed concurrently in a single module as each motion vector is analyzed.

GOP metric generator 72 operates to calculate the distance between nearest P-pictures for a picture of video signal 110. For each picture of:
1. Determine if the current picture type is a P-picture.
2. If the current picture is a P-picture, determine the distance from the previous P-picture.
3. Output the distance from the previous P-picture as the GOP metric data 80.

Decision module 62 operates to generate the transcoding indicator 44 based on the GOP metric data 80, the motion vector consistency metric data 82 and the motion vector size metric data 84. For each picture, the decision module 62 operates to generate the transcoding indicator 44 as follows:
1. Determine a small motion vector threshold, a large motion vector threshold and a motion vector difference threshold, based on picture type via a look-up table or otherwise.
2. If the current picture is a P-picture, compare the distance from the previous P-picture to a P-picture distance threshold. If the distance from the previous P-picture compares unfavorably to the P-picture distance threshold, indicating P-pictures that are too closely spaced, indicate cascade transcoding.
3. Else, compare the average motion vector size to the large motion vector threshold. If the average motion vector size compares unfavorably to the large motion vector threshold, indicating very large average motion vector size, indicate cascade transcoding.
4. Else, compare the average motion vector size to the small motion vector threshold and the small difference count to the motion vector difference threshold, if the average motion vector size compares unfavorably to the small motion vector threshold, indicating non-small average motion vector size and the small difference count compares unfavorably to the motion vector difference threshold indicating high motion vector inconsistency, indicate cascade transcoding.
5. Else, indicate direct transcoding.

The embodiment above is merely illustrative of the many possible implementations of a transcoder 102 as set forth in conjunction with FIGS. 5-7.

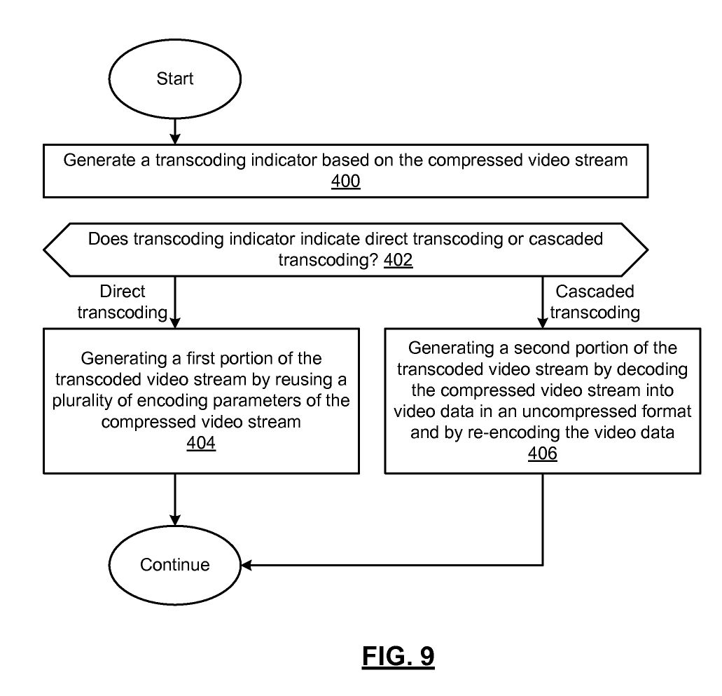

FIG. 9 presents a flowchart representation of a method in accordance with an embodiment of the present invention. In particular, a method is presented for use in conjunction with one or more functions and features presented in conjunction with FIGS. 1-8. In step 400, a transcoding indicator is generated based on the compressed video stream. In decision block 402 the method determines whether the transcoding indicator indicates a direct transcoding or cascaded transcoding. In step 404, a first portion of the transcoded video stream is generated by reusing a plurality of encoding parameters of the compressed video stream when the transcoding indicator indicates direct transcoding. In step 406, a second portion of the transcoded video stream is generated by decoding the compressed video stream into video data in an uncompressed video format and by re-encoding the video data when the transcoding indicator indicates cascaded transcoding.

In an embodiment of the present invention, the transcoding indicator is generated for the compressed video stream, in step 400, on a picture-by-picture basis. It should be noted that the transcoding indicator can also be on an MB-by-MB basis. Step 400 can include generating encoding quality metric data based on the compressed video stream and generating the transcoding indicator, based on the encoding quality metric data. Step 400 can generate the encoding quality metric data to include group of picture (GOP) metric data. Step 400 can generate the encoding quality metric data to include motion vector consistency metric data. Step 400 can generate the encoding quality metric data to include motion vector size metric data.

While particular combinations of various functions and features of the present invention have been expressly described herein, other combinations of these features and functions are possible that are not limited by the particular examples disclosed herein are expressly incorporated in within the scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or more functions such as the processing of an input signal to produce an output signal. As used herein, a module may contain submodules that themselves are modules.

Thus, there has been described herein an apparatus and method, as well as several embodiments including a preferred embodiment, for implementing a video device, and a transcoder for use therewith. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A transcoder for transcoding a compressed video stream having a sequence of pictures into a transcoded video stream, the transcoder comprising:
a direct transcoder that generates a first portion of the transcoded video stream by reusing a plurality of encoding parameters of the compressed video stream;
a cascaded transcoder that generates a second portion of the transcoded video stream by decoding the compressed video stream into video data in an uncompressed video format and by re-encoding the video data;
a transcoding decision generator that generates a transcoding indicator, based on the compressed video stream;
a switching module, coupled to the direct transcoder and the cascaded transcoder, that selects the direct transcoder for the first portion of the transcoded video stream and the cascaded transcoder for the second portion of the transcoded video stream, based on the transcoding indicator.

2. The transcoder of claim 1 wherein the transcoding decision generator generates the transcoding indicator for the compressed video stream on a picture-by-picture basis.

3. The transcoder of claim 1 wherein the switching module selects one of: the direct transcoder and the cascaded transcoder, on a picture-by-picture basis.

4. The transcoder of claim 1 wherein the transcoding decision generator includes:
a quality metric generator that generates encoding quality metric data based on the compressed video stream; and
a decision module, coupled the quality metric generator, that generates the transcoding indicator, based on the encoding quality metric data.

5. The transcoder of claim 4 wherein the quality metric generator includes:
a group of picture (GOP) metric generator that generates GOP metric data that is included in the encoding quality metric data;
wherein the decision module generates the transcoding indicator, based on the GOP metric data.

6. The transcoder of claim 4 wherein the quality metric generator includes:
a motion vector consistency generator that generates motion vector consistency metric data that is included in the encoding quality metric data;
wherein the decision module generates the transcoding indicator, based on the motion vector consistency metric data.

7. The transcoder of claim 6 wherein the motion vector consistency generator generates the motion vector consistency metric data based on a consistency threshold that is dependant on at least one of: a picture type and a macroblock type.

8. The transcoder of claim 4 wherein the quality metric generator includes:
a motion vector size generator that generates motion vector size metric data that is included in the encoding quality metric data;
wherein the decision module generates the transcoding indicator, based on the motion vector size metric data.

9. The transcoder of claim 8 wherein the decision module generates the transcoding indicator by comparing the motion vector size metric data to a threshold that is dependant on a picture type.

10. A method for transcoding a compressed video stream having a sequence of pictures into a transcoded video stream, the method comprising:
generating a transcoding indicator, based on the compressed video stream, the transcoding indicator indicating one of: a direct transcoding and cascaded transcoding;
generating a first portion of the transcoded video stream by reusing a plurality of encoding parameters of the compressed video stream when the transcoding indicator indicates direct transcoding;
generating a second portion of the transcoded video stream by decoding the compressed video stream into video data in an uncompressed video format and by re-encoding the video data when the transcoding indicator indicates cascaded transcoding.

11. The method of claim 10 wherein the transcoding indicator is generated for the compressed video stream on a picture-by-picture basis.

12. The method of claim 10 wherein generating the transcoding decision includes:
generating encoding quality metric data based on the compressed video stream; and
generating the transcoding indicator, based on the encoding quality metric data.

13. The method of claim 12 wherein the encoding quality metric data includes group of picture (GOP) metric data.

14. The method of claim 12 wherein the encoding quality metric data includes motion vector consistency metric data.

15. The method of claim 12 wherein the encoding quality metric data includes motion vector size metric data.

16. The method of claim 10 wherein the transcoding indicator is generated for the compressed video stream on a macroblock by macroblock basis.
